(19) United States
(12) Patent Application Publication
(10) Pub. No.: US 2007/0214678 A1
(43) Pub. Date: Sep. 20, 2007

(54) Drying method of clothes dryer

(75) Inventors: Chang-Woo Son, Buk-Gu (KR); Hyun-Uk Lee, Gimhae (KR); Seung-Phyo Ahn, Gimhae (KR); Dong-Joo Han, Changwon (KR); Byeong-Jo Ryoo, Changwon (KR); Jung-Wook Moon, Gimhae (KR)

Correspondence Address: KED & ASSOCIATES, LLP, P.O. Box 221200, Chantilly, VA, 20153-1200, US

(73) Assignee: LG Electronics Inc.

(21) Appl. No.: 11/714,229

(22) Filed: Mar. 6, 2007

(30) Foreign Application Priority Data
Mar. 14, 2006 (KR) 10-2006-0023715

(51) Int. Cl. F26B 3/00

(52) U.S. Cl. 34/446; 34/476; 34/491

(57) ABSTRACT

Disclosed in a control method of a clothes dryer. The drying method of a clothes dryer, includes: detecting a temperature of the air exhausted from a drum; determining a change in water content of a drying material on the basis of the detected temperature; and controlling a drying operation according to the water content change of the drying material. Accordingly, the air temperature in an exhaust port of a drum is measured, and a water content or a temperature of a drying material can be determined on the basis of data about a gradient of the temperature change.

### RELATED APPLICATION

The present disclosure relates to subject matter contained in priority Korean Application No. 10-2006-0023715, filed on Mar. 14, 2006, which is herein expressly incorporated by reference in its entirety.

### BACKGROUND OF THE INVENTION

1. Field of the Invention

The present invention relates to a drying method of a clothes dryer, and more particularly, to a drying method of determining changes in temperature and water content of a drying material on the basis of a temperature change of the exhausted air to perform a drying operation.

2. Description of the Background Art

A clothes dryer may be classified into an exhaust type and a condensation type according to a processing method of humid air generated as drying materials are dried. The former type of clothes dryer employs a method of exhausting the humid air from the drier to the outside, and the latter type of clothes dryer employs a method of condensing water vapor of the humid air exhausted from the dryer to remove moisture, and circulating the air into the dryer.

In general, an exhaust type dryer includes a drum rotatably installed in a cabinet, an inlet duct and an outlet duct connected to the drum, and a heater installed in the air induction duct.

The external air is introduced into the inlet duct by driving of a fan, and then is heated by the heater. The heating temperature reaches up to about 100° C. The hot air is introduced into the drum in the dryer to dry a drying material within the drum. Then, the hot air contains moisture of the drying material during the drying operation, and the hot, humid air is exhausted to the outside via the exhaust duct.

The conventional clothes dryer transfers heat to the introduced air using the heater may desirably reduce the time for the entire drying operation by the rapid air heating of the heater, and may have a large capacity, whereas disadvantageously consuming a large amount of energy for heating the air using the heater. Particularly, since the drying material is dried by the hot air of 100° C. or higher, damage to the drying material may occur depending on a kind of the drying material.

In contrast, the condensation type clothes dryer may be advantageously manufactured into a built-in type since the exhaust duct through which the air is exhausted to the outside is unnecessary. Also, the energy efficiency of the condensation type clothes dryer is higher than that of the exhaust type one. However, disadvantageously, the condensation type clothes dryer requires long time, and it is difficult to manufacture this type of dryer to have a large capacity.

For those reasons, an improved clothes dryer having great energy efficiency and causing no damage to a drying material is needed, and a more stable drying method with higher efficiency is also required.

In the conventional automatic drying method of a clothes dryer, the time to terminate a drying stroke during a drying process is determined with respect to a water content of a drying material set by a user. To determine the water content, a resistance value change is obtained according to the water content of the drying material using an electrode sensor.

However, as illustrated in FIG. 1, an electrode sensor 22 of a dryer 10 is placed at one side of a front portion within a drum 20, and thus can detect only a drying material placed at the front side within the drum 20. Consequently, a water content of every drying material within the drum 20 cannot be detected.

Also, since the drum 20 is rotated about a horizontal axis, most of drying materials is moved only vertically within the drum 20, without being moved horizontally, the electrode sensor 22 can detect only a drying material placed at the front side within the drum. Thus, a drying material placed at the rear of the drum cannot contact the electrode sensor 22, and therefore the drying-material sensing ability of the electrode sensor 22 is deteriorated.

As for a drying method, as illustrated in FIG. 2, a voltage change (ERTD) of the electrode sensor 22 is measured, and an additional drying operation is performed from the time point when a voltage of the electrode sensor 22 is saturated. In the method of adding the drying time, a final water content desired by a user may vary according to a kind of a drying material (e.g., clothes dried fast, and clothes dried slowly).

Accordingly, a new type of clothes dryer is required, which is able to stably and efficiently perform a drying operation, regardless of a kind or the amount of drying materials.

### BRIEF DESCRIPTION OF THE INVENTION

Therefore, an object of the present invention is to provide a method of controlling a clothes dryer capable of constantly and stably performing a drying operation, regardless of the amount and kind of a drying material.

Another object of the present invention is to provide a method of controlling a clothes dryer capable of meeting consumer demand for a drying level and implementing various drying modes, without adding complicated elements and greatly changing an internal structure of a clothes dryer.

To achieve these and other advantages and in accordance with the purpose of the present invention, as embodied and broadly described herein, there is provided a drying method of a clothes dryer, including: detecting a temperature of the air exhausted from a drum; determining a change in water content of a drying material on the basis of the detected temperature; and controlling a drying operation according to the water content change of the drying material.

Preferably, the determining of the water content change of the drying material determines the following at least three periods: a) an initial preheating period of the drying material; b) a constant rate (isothermal) drying period of the drying material; and c) an overheating drying period of the drying material.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view illustrating an exterior of a conventional clothes dryer;

FIG. 2 is a graph for describing a drying method of a conventional clothes dryer;

FIGS. 3A and 3B are views illustrating an exterior and an internal structure of a clothes dryer according to an embodiment of the present invention;

FIG. 4 is a graph for describing a principle of a drying method according to an embodiment of the present invention;

FIGS. 5A and 5B are graphs showing a water content and a temperature change in an actual drying process of a drying material;

FIG. 6 is a graph showing a temperature change gradient according to an embodiment of the present invention; and

FIG. 7 is a flow chart exemplarily illustrating a drying method according to the present invention.

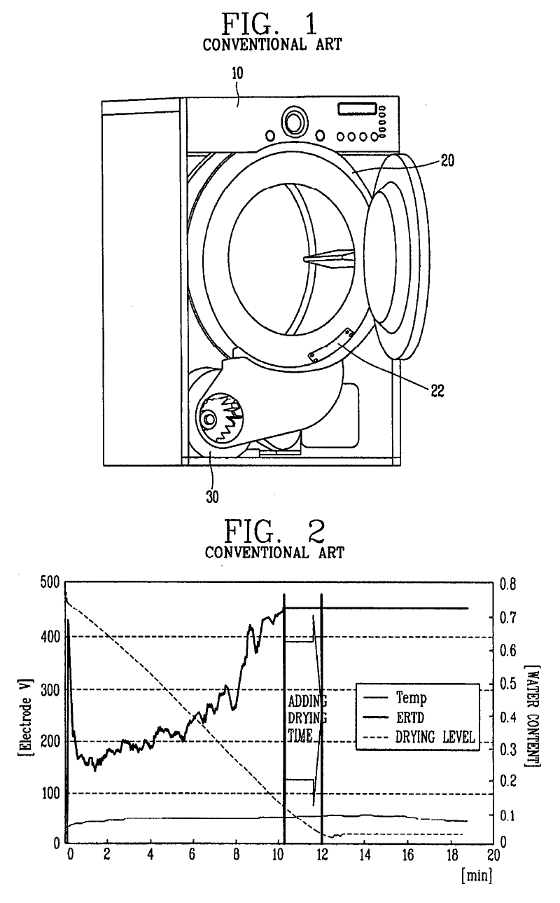

### DETAILED DESCRIPTION OF THE INVENTION

Reference will now be made in detail to the preferred embodiments of the present invention, examples of which are illustrated in the accompanying drawings.

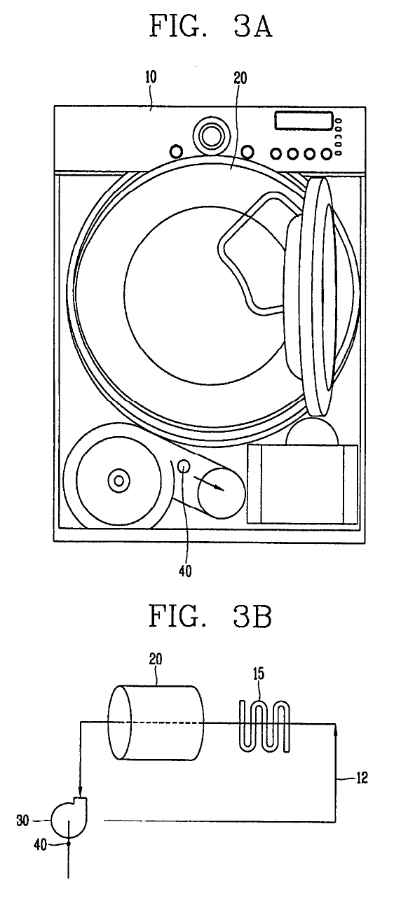

Referring to FIGS. 3A and 3B, a clothes dryer 10 according to an embodiment of the present invention includes a sensor 40 detecting a temperature (or, humidity) of exhaust air. The sensor 40 is installed on a flow path of the air discharged from a drum 20, preferably, near to an air flow fan 30.

The sensor 40 continuously detects a temperature (or humidity) of the air exhausted from the drum 20 after being heated by the heater 15, introduced into the drum 20 through an air path 12, and absorbing moisture from a drying material (not shown) during a drying operation. Data of the detected air temperature (or humidity) is transmitted to a controller (not shown) such as a micom mounted within the dryer 10 in real-time.

The data transmitted to the controller in real-time is used as a basic material for determining a dried degree change and a water content of the drying material according to the drying process.

Unlike the conventional method of controlling heat from the heater to a desired temperature simply by determining a dried degree (or, water content of a drying material) over time of a drying operation in an existing drier, in the present invention, a water content of clothes is detected during the drying operation using a pattern of a temperature (or humidity) change of the air exhausted from the drum, and a dried degree of the drying material is determined according to the detected water content change, so as to control the drying operation of the clothes dryer.

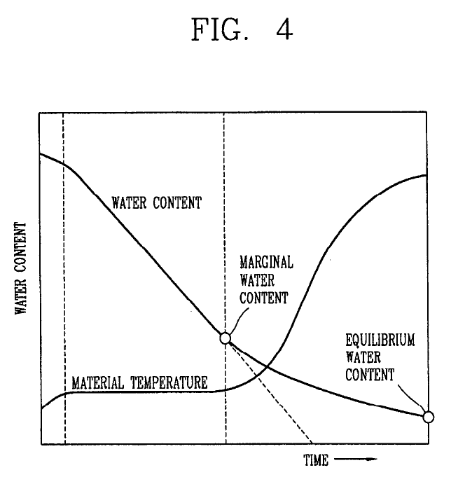

Hereinafter, a basic principle of the method of drying the clothes dryer according to an embodiment of the present invention will now be described with reference to FIG. 4.

As the drying operation is performed, the water content of a drying material loaded in the drum decreases over time. Also, the temperature of the drying material continuously changes as the hot air supplied to the drum absorbs moisture of the drying material. The temperature change occurs through several processes illustrated in FIG. 4.

First, a first process (I) is a preheating process of preheating the drying material to a predetermined temperature or higher. In the first process (I), the water content of the drying material decreases while its temperature increases. In this case, the gradient of the water content gently decreases.

Next, a second process (II) id a constant rate drying period, that is, an isothermal drying period in which the temperature of the drying material is not changed. Since thermal energy generated from the heater is used as evaporation energy for drying moisture of the drying material in the second process (II), the water content of the drying material decreases, whereas the temperature of the drying material is constant. Thus, the temperature change of the drying material is almost zero, and the gradient of the water content becomes constant.

Finally, in a third process (III), energy of the heater (i.e., energy of hot air supplied to the drum) is converted into preheating energy increasing the temperature of the drying material, and thus the temperature of the drying material sharply rises. In the third process (III), the water content of the drying material gently decreases, and this corresponding period may be considered a decreasing rate drying period.

The method of drying the clothes dryer according to the present invention, in order to predict the water content change of the drying material on the basis of the temperature change of the drying material, the sensor placed toward an exhaust port of the drum detects the temperature of the exhaust air. When a heater caloric value is modulated on the basis of the temperature change pattern over time, the drying operation may be performed in an automatic drying mode proper to the dried condition of the drying material.

If the water content at the time point when the gradient of the water content, which is constant, starts to fall, that is, when the process is changed from the second process (II) to the third process (III) is defined as a marginal water content, and the water content at a spot where the change curve of the temperature (material temperature) of the drying material meets a straight line where the water content gradient is fixed is defined as a marginal preheating point, it is experimentally confirmed that almost the same water content is obtained at the marginal preheating point, regardless of the amount of the drying material.

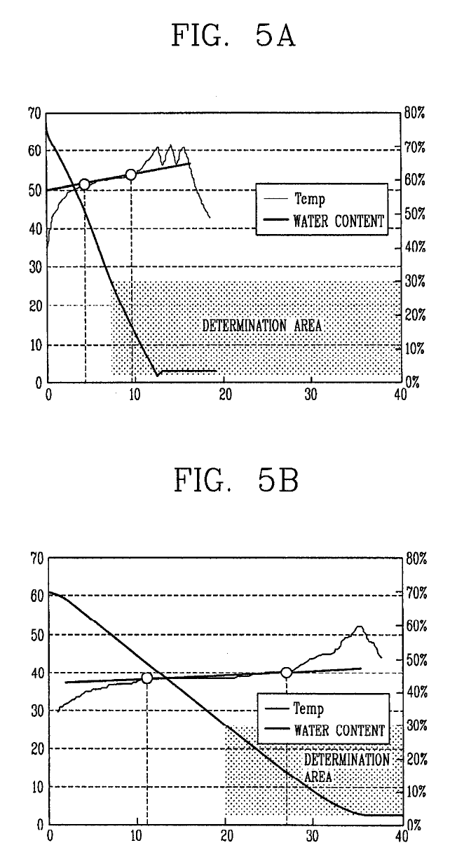

FIGS. 5A and 5B are graphs showing a water content change and a temperature change of a drying material during a drying operation for 1 Kg of drying material, and 5 Kg of drying material, respectively. Similar temperature changes and water content changes with respect to the respective drying materials are measured. As a result of determining the water content on the basis of the temperature of the air coming out of the drum as the drying material containing moisture is dried, the temperature of the dryer (i.e., temperature of the drying material) increases at an initial stage of the drying operation, and then, the temperature of the air exhausted from the drum is linearly maintained at a middle stage of the drying operation, i.e., during the constant rate drying period since thermal energy from the heater evaporators moisture of the drying material. At a final stage of the drying operation, i.e., during the decreasing rate drying period, the thermal energy increases the temperature of the drying material and the temperature of the air exhausted to the outside through the exhaust port is also increased since the drying material has almost no moisture.

In comparison of the water contents at the marginal preheating point from the measured result, it can be seen that about 18% of water content is measured with respect to both 1 Kg of drying material and 5 Kg of drying material.

Accordingly, the air temperature change is measured using the sensor placed at an exhaust path through which the air is exhausted from the drum, and the detected temperature change is analyzed so that the drying operation is executed by setting an automatic drying mode with reference to the time point when the temperature change rate is constant, and the time point when the temperature change rate increases from the constant change rate value. Consequently, the drying operation can be performed constantly, regardless of the amount of drying material loaded in the drum.

Thus, the present invention is characterized in that the controller determines a change rate of the air temperature, that is, a gradient change in the air temperature change graph on the basis of air temperature data provided from the sensor in order to determine individual drying periods during the drying operation.

The present invention is also characterized in that accurate temperature change data is obtained by obtaining the gradient of the temperature change as a moving average.

The temperature change data can be obtained by increasing the gradient of the temperature change during a unit time (unit period), for example, for 10 seconds, in units of one second. That is, the average gradient value is obtained according to time moving in order of an initial start time point˜10 seconds (a first period), 2 seconds˜11 seconds (a second period), 3 seconds˜12 seconds (a third period), . . . , n seconds˜n+10 seconds (n period), and the gradient of the air temperature change in the exhaust port is determined on the basis of the obtained data.

The moving average is obtained by the following equation such that the gradient change (A gradient) is obtained using the maximum gradient (Max) and the minimum gradient (Min) with respect to the unit time (unit period) (T).

Δ gradient=(Max(T)−Min(T))/T

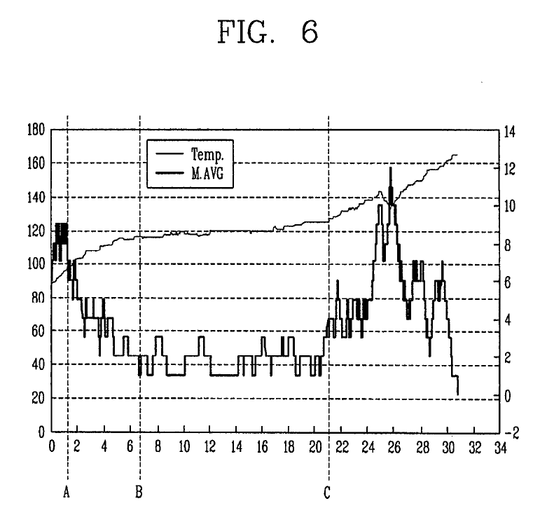

FIG. 6 is a graph showing the gradient change value during an actual drying operation. The temperature change gradient change is somewhat unsteady during an initial drying process, and decreases up to the time point B after the time point A. This period is a preheating period of a drying material. In the preheating period, the temperature of the drying material increases, while the increasing rate of the temperature change gradually slows. Then, the temperature of the drying material is constant until the time point C, and thus the gradient of the temperature change is almost fixed. Thereafter, the temperature of the drying material keeps increasing, and the gradient of the temperature change gradually increases.

During the drying operation, the time point for decreasing the heat radiation level of the heater or stopping the operation thereof may be determined at the time point when the moving average increases from a constant value (specifically, the time point C in FIG. 6).

According to the present invention, the water content (FMC) of the drying material varies according to a drying mode, so that the drying can be made through various drying modes. Table 1 below shows an exemplary drying mode.

TABLE 1
Various drying modes

| | | Middle | | Additional |
|---|---|---|---|---|
| | Initial drying | drying | Final drying | drying |
| General | 10% < FMC < | 5% < FMC, | FMC < 6% | FMC < 4% |
| mode | 28% | 15% | | |

| | |
|---|---|
| Speedy | FMC < 7 |
| mode | |

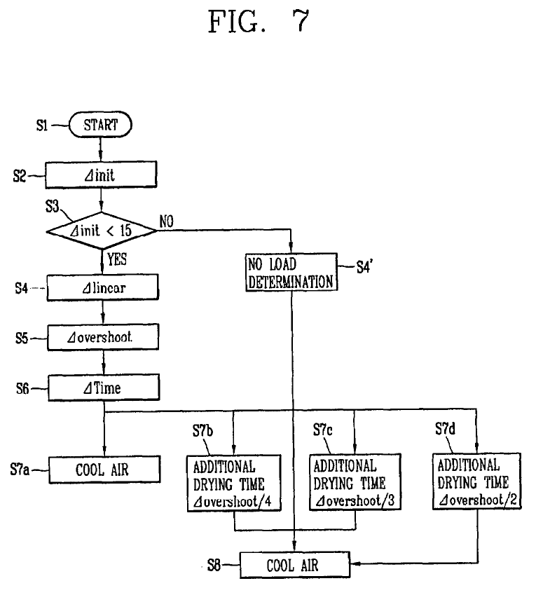

FIG. 7 is a flow chart exemplary showing a drying method of a clothes dryer according to the present invention. When a drying operation is started (S1), the maximum value (Δinit) of a gradient of an exhaust-port temperature change is obtained at an initial stage (e.g., 0˜3 miniute period) (S20). The gradient of the temperature change is obtained by the aforementioned moving average obtaining method. When it is determined that Δinit is smaller than a predetermined value (e.g., 15) (S3), the next process is performed to continuously obtain the gradient of the temperature change. When Δinit becomes greater than the predetermined value, it is determined that there is no load, that is, no material to be dried (S4′), and the operation of the heater is stopped to perform cool air drying (S8). When the temperature change gradient becomes constant during the drying operation, it is determined that the current period corresponds to a middle stage starting point (Δlinear) (S4), and the next process is performed. The middle stage starting point (Δlinear) may be set to about a middle point (Δinit/3) between the initial and middle stages. In the next process, the time point when the gradient of the temperature change increases is determined as a start point (Δovershoot) of a final stage of the drying (S5), and the next process is performed. The start point (Δovershoot) of the final stage of the drying may be set to, for example, about a middle point (Δinit/2) between the middle and final stages of the drying. When a predetermined time elapses (ΔTime) (S6), the drying operation may be performed in each automatic drying mode pre-selected by a consumer (S7a˜S7b).

The drying operation according to the present invention may be very consistent and uniform regardless of a kind or amount of drying materials, by detecting the temperature change of the air exhausted from the drum and analyzing the gradient change of the temperature change. Also, such a drying method may be applied not only to the clothes dryer but also to a washing machine with dryer. Also, only a sensor and a drying mode controller are installed without any complicated element, so that the drying can be performed more smoothly and accurately.

As described so far, the control method of the clothes dryer according to an embodiment of the present invention may allow an accurate drying operation since the air temperature in the exhaust port of the drum is measured, and a water content or a temperature is determined on the basis of data about the gradient of the air temperature change. The present invention may be applied to both a clothes dryer and a washing machine with a dryer in the same manner, and allows effective automatic drying, regardless of a kind and amount of a drying material.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A drying method of a clothes dryer, comprising:
detecting a temperature of the air exhausted from a drum;
determining a change in water content of a drying material on the basis of the detected temperature; and
controlling a drying operation according to the water content change of the drying material.

2. The method of claim 1, wherein the determining of the water content change of the drying material uses a temperature change pattern of the exhausted air over time.

3. The method of claim 1, wherein the determining of the water content change of the drying material determines the following at least three periods:
a) an initial preheating period of the drying material;
b) a constant rate (isothermal) drying period of the drying material; and
c) an overheating drying period of the drying material.

4. The method of claim 1, wherein the determining of the water content change of the drying material comprises obtaining a gradient of a temperature change over a predetermined period time, and setting a drying period on the basis of accumulation data of the gradient change.

5. The method of claim 4, wherein the accumulation data of the gradient change is obtained by continuously obtaining a gradient of a temperature change of a predetermined time (predetermined period) with respect to a unit time.

6. The method of claim 1, wherein in the determining of the water content change of the drying material, the water content change is determined on the basis of a gradient change of a temperature change of the exhausted air.

7. The method of claim 6, wherein a drying operation of the drying material is controlled with reference to a time point when the gradient of the temperature change becomes constant, and a time point when the gradient of the temperature change increases.

8. The method of claim 6, wherein the gradient change (Δgradient) of the temperature change of the exhausted air is determined by the following equation using a maximum gradient (Max) and a minimum gradient (Min) with respect to a predetermined time (predetermined period) (T):
Δ gradient=(Max(T)−Min(T))/T
